(19) United States
(12) Patent Application Publication
(10) Pub. No.: US 2026/0046098 A1
(43) Pub. Date: Feb. 12, 2026

(54) SYSTEM AND METHOD FOR COMBINING AND SEPARATING NON-ORTHAGONAL SIGNALS IN MULTI-CHANNEL COMMUNICATION SYSTEMS AND MULTIPLE ACCESS SYSTEMS

(71) Applicant: Joseph Brifman, Flagler Beach, FL (US)

(72) Inventor: Joseph Brifman, Flagler Beach, FL (US)

(21) Appl. No.: 18/942,880

(22) Filed: Nov. 11, 2024

Related U.S. Application Data
(60) Provisional application No. 63/597,943, filed on Nov. 10, 2023.

(51) Int. Cl. H04L 5/00; H04B 1/00; H04L 1/00; H04L 7/00

(52) U.S. Cl. CPC H04L 5/0092; H04B 1/0028; H04L 1/0058; H04L 5/0005; H04L 7/0012

(57) ABSTRACT

A system and method for combining and separating non-orthogonal signals. A transmitting component includes a set of generators of non-orthogonal signals and an adder for forming a group mixture. A receiving component includes a band-pass selective filter, an analog-to-digital converter and a calculator-solver for separating signals or channels. The system and method are designed to provide an almost ideal channels separation due to a new original group mixture processing procedure performed by the calculator-solver. The system and method provide significant increase in noise-immunity and the achievement of transmission rates that are exceeded the Shannon's Capacity of the group path.

### CROSS-REFERENCE TO RELATED APPLICATION

The present application claims priority to, and the benefit of, U.S. Provisional Application No. 63/597,943, which was filed on Nov. 10, 2023 and is incorporated herein by reference in its entirety.

### BACKGROUND

The present invention generally relates to ways to combine and separate non-orthogonal signals, and more specifically to systems and methods of combining and separating non-orthogonal signals in multi-channel communication systems and multiple access systems of telecommunication systems that use a common time-frequency resource to transmit of data from multiple sources. Accordingly, the present specification makes specific reference thereto. However, it is to be appreciated that aspects of the present invention are also equally amenable to other like applications, devices, and methods of manufacture.

Currently there are three main multi-channels technologies that are used for communication systems that serve multiple interacting subscribers. As illustrated in FIGS. 1A-C, these technologies include Frequency Division Multiple Access (FDMA); Time Division Multiple Access (TDMA); and Code Division Multiple Access (CDMA). The first word in these names denotes the kind of physical resource of the multi-user channel that is used to separate independent users. The main idea for achievement effective operation known systems is to use the orthogonality property on the corresponding parameter of the group physical resource of the channel. Sometimes these technologies can be used together in various combinations.

The FDMA bandwidth is divided into various frequency bands. Each station is allocated with band to send data and that band is reserved for particular station for all the time which is as shown in the FIG. 1A. The frequency bands of different stations are separated by small bands of unused frequency and those unused frequency bands are called as guard bands that prevent the mutual interference of stations. This is similar to an access method in the data link layer in which the data link layer at each station tells its physical layer to make a band pass signal from the data passed to it. The signal is created in the allocated band and there is no physical multiplexer at the physical layer.

An independent operation of multiple stations is possible due to the property of frequency orthogonality:

$${\int }_{T} {s}_{i} ( t , f ) \cdot {s}_{j} ( t , f ) df ≅ 0 , i \neq j \qquad Equation ( 1 )$$

Each individual channel has a size (volume) Vᵢ=T·Δfᵢ, i∈1, 2, . . . n, where T—channel usage time; Δfᵢ—i-th channel bandwidth; n—number of combined channels. The total size (volume) of the group channel is greater than the sum of n volumes of the individual channels due to the use of guard intervals:

$${V}_{FDMA} = ( {\sum }_{i = 1}^{n} Δ {f}_{i} + {\sum }_{i = 1}^{n - 1} Δ {f}_{G} ) \cdot T > T \cdot {\sum }_{i = 1}^{n} Δ {f}_{i} , \qquad Equation ( 2 )$$

where Δf_{G}—frequency band of each (n−1) guard interval.

The main disadvantages of FDMA include too large size (volume) of the group channel, which determined by the sum of the volumes of individual channels and sum of the guard intervals; bulkiness of analog channel-forming equipment; little noise immunity, including with respect to mutual crosstalk; little flexible; and low specific information rate and too low effectiveness of the using of group frequency-time resource, as a results of previous shortcomings.

TDMA is the channelization protocol in which bandwidth of channel is divided into various stations on the time basis. There is a time slot Δtᵢ given to each station, the station can transmit data during that time slot only which is as shown in the FIG. 1B.

An independent operation of multiple stations is possible due to the property of orthogonality in time:

$${\int }_{T} {s}_{i} ( t , f ) \cdot {s}_{j} ( t , f ) df ≅ 0 , i \neq j \qquad Equation ( 1 )$$

Each station must aware of its beginning of time slot and the location of the time slot. TDMA requires synchronization between different stations. It is a type of access method in the data link layer. At each station data link layer tells the station to use the allocated time slot. There are guard time intervals needed to defend from mutual influence between neighboring slots. Those, the total size (volume) of the TDMA group channel also is larger than the sum of n volumes of the individual channels due to the use of guard times:

$${V}_{TDMA} = ( {\sum }_{i = 1}^{n} Δ {t}_{i} + {\sum }_{i = 1}^{n - 1} Δ {t}_{G} ) \cdot F > F \cdot {\sum }_{i = 1}^{n} Δ {t}_{i} , \qquad Equation ( 3 )$$

where Δt_{G}—the duration of a guard interval.

The main disadvantages of TDMA include mode of data transfer is signal in bursts; hard synchronization is needed; little noise immunity, including with respect to natural noise, mutual crosstalk and inter symbol interference; and medium specific information rate and too low efficiency of the using of group frequency-time resource, as a results of previous shortcomings.

CDMA is the channelization protocol in which all the stations can transmit data simultaneously. It allows each station to transmit data over the entire frequency all the time. Multiple simultaneous transmissions are separated by a unique code sequence. Each user is assigned with a unique code sequence. As illustrated in FIG. 1C, there are three stations marked as one, two and three. The code assigned with respective stations as C₁, C₂, C₃. These codes consist of binary symbols, each of them can takes one of possible values “+1” and “−1”, and these code sequences created the system of orthogonal (or quasi orthogonal) vectors:

$${C}_{i} \times {C}_{j} ≅ 0 , if i \neq j , \qquad Equation ( 4 )$$

where “X” is a dot product operation.

Before combining into a group channel, signals of each individual channel are artificially increased in volume by n times (n is the total number of individual channels). Typically, this operation is performed by replacing elementary symbols with sequences consisting of shorter (by n times) channel symbol-chips. This leads to increasing frequency band and, respectively, size (volume) of each individual signal by n times. This operation is called “artificial spectrum spreading”. Those, each individual signal occupies whole group channel volume, equal F·T.

The total size (volume) of the CDMA group channel is at least equal the sum of n volumes of the individual channels:

$${V}_{CDMA} \geq T \cdot F = T \cdot ( {V}_{1} + {V}_{2} + {V}_{3} ) = [ \begin{matrix}for common case \\ if number of channels = n\end{matrix} ] = T \cdot {\sum }_{i = 1}^{n} \frac{F}{n} . \qquad Equation ( 5 )$$

The main disadvantages of CDMA are that special orthogonal codes are needed; synchronization is needed; and the same main shortcomings of the other protocols including insufficient noise immunity, average specific information rate and too low efficiency of using the group time-frequency resource, because the volume of the group channel can be greater than the volume of the individual channel by at least n times.

The main conclusion from a FDMA, TDMA and CDMA analysis is that the possibility of multiple source data transmitting through common time-frequency resource only exist due to use of orthogonality property. However, in the same time, the need to use too much time-frequency resource of the group channel is also a consequence of the orthogonality property of signals in individual channels. If orthogonality is refused, the possibility to decrease the size (volume) of group channel exists. But in this case, it is necessary to maintain (or increase) the degree of distinguishability and noise immunity of the signals of individual channels. Namely this complex problem solves the invention.

Accordingly, there is a great need for a way to separate non-orthogonal signals in multi-channel communication systems and multiple access systems. There is also a need for a way to combine non-orthogonal signals in multi-channel communication systems and multiple access systems. Similarly, there is a need for a better way to transmit data from multiple sources in telecommunication systems that use a common time-frequency resource. Further, there is a need for a system provides a significant increase in noise-immunity and the achievement of transmission rates that exceed the Shannon's Capacity of the group path.

In this manner, the improved systems and methods of combining and separating non-orthogonal signals of the present invention accomplishes all of the forgoing objectives, thereby providing a solution for a better way to transmit data from multiple sources in telecommunication systems that use a common time-frequency resource that provides a significant increase in noise-immunity and the achievement of transmission rates than existing systems and methods.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The subject matter disclosed and claimed herein, in one embodiment thereof, comprises a system for combining and separating non-orthogonal signals in multi-channel communication systems and multiple access systems. The system comprises a transmitting side comprising a set of non-orthogonal signal generators and an adder. The system further comprises a receiving side comprising a band pass filter, an analog-to-digital converter and a solver-separator. The receiving side is configured to accept a group mixture from the transmitting side via a group channel with noise and provide a channel separation of the plurality of non-orthogonal signals.

The set of non-orthogonal signal generators is modulated by a block of bits from an information source. The set of non-orthogonal signal generators and the adder are configured to generate the group channel. The set of non-orthogonal signal generators and the analog-to-digital converter are controlled by a system clock.

The system is configured to reduce a required frequency-time resource of the group channel of the multichannel system and to provide an increase in noise immunity. The solver-separator is configured to provide a discrimination of a plurality of signals of individual channels and protection against noise distortion. The solver-separator is further configured to distribute decoded data to a subscriber.

The subject matter disclosed and claimed herein, in one embodiment thereof, comprises a system for combining and separating non-orthogonal signals in multi-channel communication systems and multiple access systems. The system comprises a channel forming component comprising a plurality of binary data sources, a set of non-orthogonal signal generators, and an adder. The system further comprises a separating component comprising a band pass filter, an analog-to-digital converter and a solver-separator. The separating component is configured to accept a group mixture from the channel forming component via a group channel with noise and provide a channel separation of the plurality of non-orthogonal signals.

The channel forming component is configured to generate a common group channel signal as a sum of modulated individual non-orthogonal signals. The band pass filter is a band pass selective filter configured to limit an effective spectrum of a signal-to noise mixture. The set of non-orthogonal signal generators and the analog-to-digital converter are controlled by a system clock.

The analog-to-digital converter is configured to transform a group signal into a digital form with a required sample rate. The solver-separator is in communication with the band pass filter and the analog-to-digital converter. The solver-separator is further configured to solve a system of linear algebraic equations based on a linear separating matrix.

The subject matter disclosed and claimed herein, in one embodiment thereof, comprises a method for combining and separating non-orthogonal signals in multi-channel communication systems and multiple access systems. The method comprises providing a channel forming component comprising a plurality of binary data sources, a set of non-orthogonal signal generators, and an adder; providing a separating component comprising a band pass filter, an analog-to-digital converter and a solver-separator; dividing a plurality of sequences of binary data symbols into a plurality of symbol blocks to modulate individual signals; combining the plurality of symbol blocks with the adder to generate a common group channel signal as a sum of the modulated individual non-orthogonal signals; limiting an effective spectrum of a signal-to noise mixture with the band pass filter; and using the solver-separator to provide a discrimination of the signals of individual channels protected against noise distortion. The method further comprises synchronizing the set of non-orthogonal signal generators and the analog-to-digital converter with a system clock, wherein the solver-separator is configured to solve a system of linear algebraic equations based on a linear separating matrix.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and is intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates an illustrative embodiment of a resource division for different known protocols for FDMA, TDMA, and CDMA in accordance with the disclosed architecture.

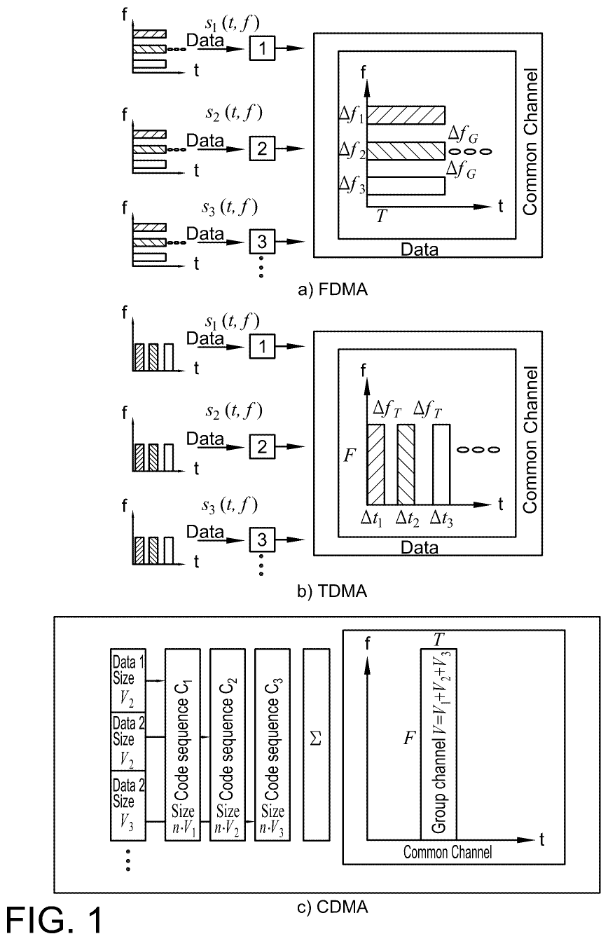

FIG. 2 illustrates an illustrative embodiment of a resource sharing (time-shift (TS) and frequency-shift (FS)) protocol including a displacement in time, a displacement in frequence, and a combined displacement of the present invention in accordance with the disclosed architecture.

FIG. 3 illustrates an illustrative embodiment of a protocol based on the differences of signal durations (duration-change (DC) method) of the present invention in accordance with the disclosed architecture.

FIG. 4 illustrates a schematic of a multichannel system for combining and separating non-orthogonal signals of the present invention in accordance with the disclosed architecture.

FIG. 5 illustrates a structure of matrix A and matrix-column B of the SLAE of Equation (11) of the present invention in accordance with the disclosed architecture.

FIG. 6 illustrates a schematic of a set of signals of the individual channels using the time shift method of the present invention in accordance with the disclosed architecture.

FIG. 7 illustrates a graphical representation of a matrix of CCM values of the mutual correlation between signals using the TS-method of the present invention in accordance with the disclosed architecture.

FIG. 8 illustrates a graphical representation of a BPF frequency response of the present invention in accordance with the disclosed architecture.

FIG. 9 illustrates a graphical representation of a BPF noise filtering process when F_{N}=1000 [Hz], T_{N}=2 [s] with a noise implementation at the BPF input and a noise implementation after BPF filtering of the present invention in accordance with the disclosed architecture.

FIG. 10 illustrates a graphical representation of a BPF impulse function of the present invention in accordance with the disclosed architecture.

FIG. 11 illustrate a graphical representation of a BPF signal filtering process for example using x(t,0) at the BPF input and after BPF filtering of the present invention in accordance with the disclosed architecture.

FIG. 12 illustrates a graphical representation of results for a statistical verification of the TS-method of group channel implementation at h_{N}=0.1 of the present invention where the well-known classic reception methods of orthogonal and biorthogonal signals have a BER=0.34 in accordance with the disclosed architecture.

FIG. 13 illustrates a graphical representation of results for a statistical verification of the TS-method of group channel implementation at h_{N}=1 of the present invention where the well-known classic reception methods of orthogonal and biorthogonal signals have a BER=0.078 in accordance with the disclosed architecture.

FIG. 14 illustrate a graphical representation of normalized amplitude spectra of single and group signal using the TS-method at 74 [Hz] and 52 [Hz] of the present invention in accordance with the disclosed architecture.

FIG. 15 illustrates a graphical representation of a set of signals of the individual channels using the combined time shift (TS)+duration-change (DC) method of the present invention in accordance with the disclosed architecture.

FIG. 16 illustrates a graphical representation of a matrix of CCM values of the mutual correlation between signals using the TS+DC-method of the present invention in accordance with the disclosed architecture.

FIG. 17 illustrates a graphical representation of a normalized amplitude spectra of single and group signal using the TS+DC-method of the present invention in accordance with the disclosed architecture.

FIG. 18 illustrates a graphical representation of results for a statistical verification of the TS+DC-method of group channel implementation at h_{N}=0.1 of the present invention where the well-known classic reception methods of orthogonal and biorthogonal signals have a BER=0.34 in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They do not intend as an exhaustive description of the invention or do not limit the scope of the invention. Additionally, an illustrated embodiment need not have all the aspects or advantages shown. Thus, in other embodiments, any of the features described herein from different embodiments may be combined.

The main purpose of the invention is to significantly increase the specific efficiency of using the group time-frequency resource, increase the noise immunity of the system, and significantly reduce the required size (volume) of the group channel while increasing the number of subscribers served. The invention employs the use of non-orthogonal signals and a specially developed mathematical processing procedure of extremely accurate separation of non-orthogonal signals. The main means of achieving a new result is the introduction of three new parameters for distinguishing individual signals in the group channel. In addition to the known frequency, time and code separation, the invention utilizes differences in the start time moment of signals, differences in the duration of the individual channel signals, and differences in slightly shifted frequency spectra of individual signals. In these cases, signal of different channels can significantly overlap in time and frequency spectrum, using the common physical resource of the group channel.

The present invention, in one exemplary embodiment, is a system for combining and separating non-orthogonal signals in multi-channel communication systems and multiple access systems. The system of the present invention relates to telecommunication systems that use a common time-frequency resource to transmit of data from multiple sources. A transmitting side of the system includes a set of generators of non-orthogonal signals and an adder for forming a group mixture, each of generators is modulated by block of bits from the one own information source. A receiving side of the system includes a band-pass selective filter, an analog-to-digital converter and a special calculator-solver for separating signals or channels. The method and system for its implementing provide an almost ideal channels separation due to a new original group mixture processing procedure performed by the calculator-solver. In addition, the system provides significant increase in noise-immunity and the achievement of transmission rates that are exceeded the Shannon's Capacity of the group path.

The system comprises a transmitting side comprising a set of non-orthogonal signal generators and an adder. The system further comprises a receiving side comprising a band pass filter, an analog-to-digital converter and a solver-separator. The receiving side is configured to accept a group mixture from the transmitting side via a group channel with noise and provide a channel separation of the plurality of non-orthogonal signals.

The set of non-orthogonal signal generators is modulated by a block of bits from an information source. The set of non-orthogonal signal generators and the adder are configured to generate the group channel. The set of non-orthogonal signal generators and the analog-to-digital converter are controlled by a system clock.

The system is configured to reduce a required frequency-time resource of the group channel of the multichannel system and to provide an increase in noise immunity. The solver-separator is configured to provide a discrimination of a plurality of signals of individual channels and protection against noise distortion. The solver-separator is further configured to distribute decoded data to a subscriber.

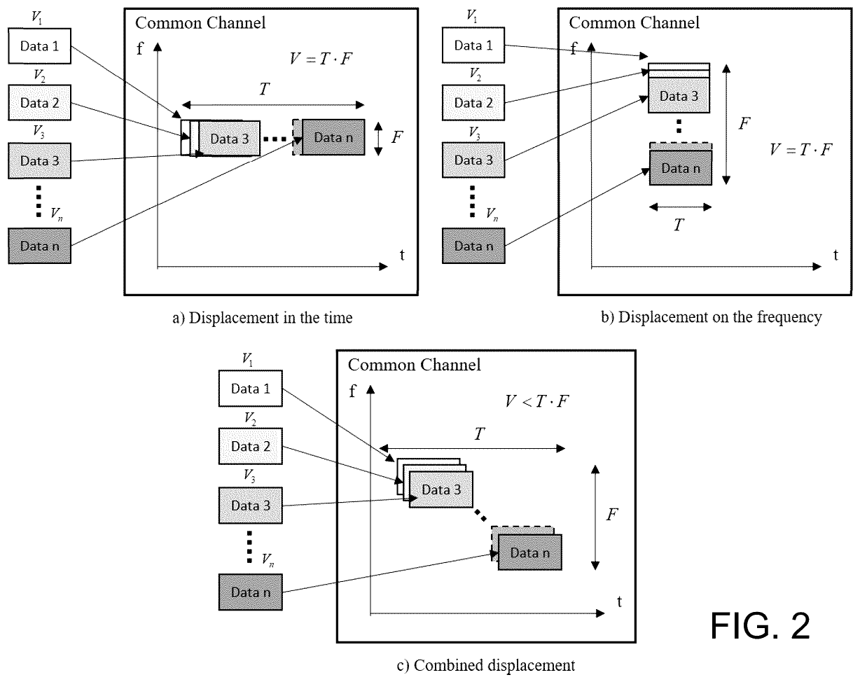

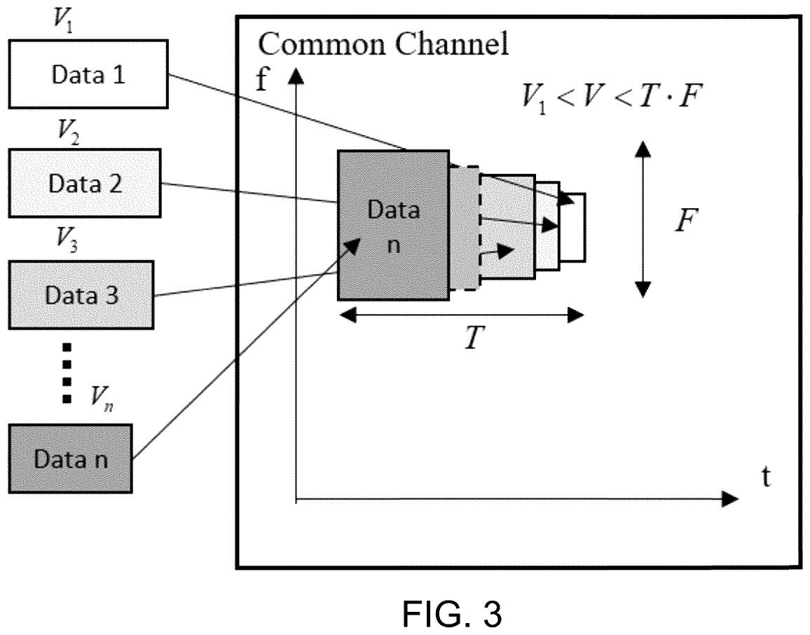

FIGS. 2A-C and 3 illustrate the protocol of the new multi-channel technology (multiple access). In FIGS. 2A and 2B, two basic protocols of the division of group resource for placement non-orthogonal individual signals are shown. The original signals have the same size (volume) Vᵢ, i∈1, 2, . . . , n and are placed in the group channel with a small mutual shift in time (FIG. 2A) or frequency (FIG. 2B) or combined by shift both in time and frequency (FIG. 2C). FIG. 3 shows the arrangement when the signals of the individual channels start at the same time, have partially overlapping spectra, but have different durations.

At all such kinds of the placement, significant parts of signals volumes overlap in the time or on the frequency. In this case, the required size (volume) of the group channel is sharply reduced, which is a goal of the invention. However, in this case, individual channels leave mutual orthogonality, so their processing and selection in the usual way become impossible. It is also fair to assume that due to a decrease in the degree of distinguishability of signals, a strong decrease in noise immunity will occur. However, this is not true, because a new algebraic processing procedure that provides not only perfect signal detection, but also a significant increase in noise immunity is illustrated infra.

An estimate of the reduction in the required volume of the group channel for the simplest examples of placements is shown in FIGS. 2A and B. For the well-known methods of implementing a group channel FDMA, TDMA, CDMA discussed above, the required channel size can be estimated as follows:

$${V}_{known} \geq {\sum }_{i = 1}^{n} {V}_{i} = n \cdot {V}_{1} , \qquad Equation ( 6 )$$

where Vᵢ, i=1, 2, . . . n indicates volumes of individual channels.

When the volume overlap coefficient 0≤K≤1 shown in FIGS. 2A and B is introduced, this shows what common part of each individual volume is common to two adjacent individual channels in a group scheme. Then the value of required group volume is determined as follows:

$${V}_{new} = {V}_{1} \cdot [ 1 + n ( 1 - K ) ] . \qquad Equation ( 7 )$$

Then the gain in volume reduction will be

$$Gain = \frac{{V}_{known}}{{V}_{new}} = \frac{n}{1 + n ( 1 - K )} . \qquad Equation ( 8 )$$

If we assume that n=100, K=0.75, then Gain 4 times.

The volume reduction achieved is quite understandable, since the individual channels, when orthogonality is abandoned, are placed with a large overlap. So, it must be shown that the channels can be much more distinct and more protected from noise when a special digital algebraic processing procedure of the present invention is employed.

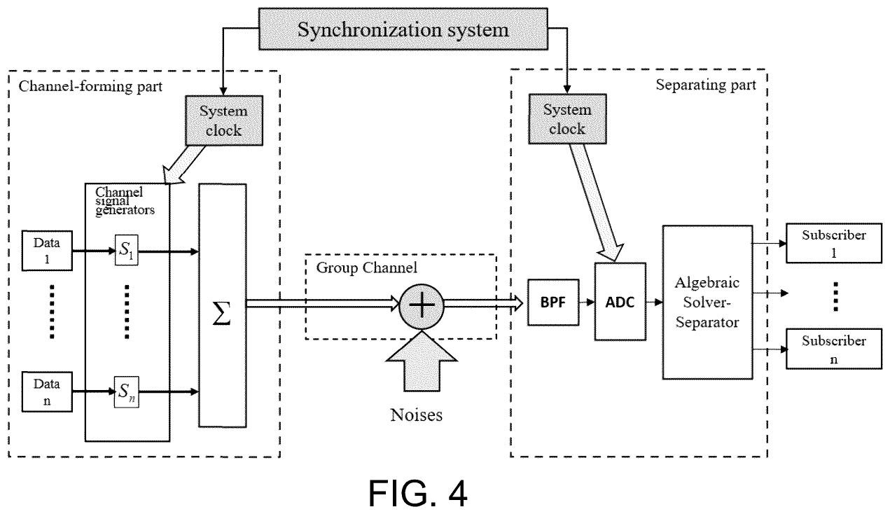

FIG. 4 illustrates a of a multi-channel system for combining and/or separating non-orthogonal signals. The system comprises a channel-forming component comprising a plurality of n binary data sources (Data 1”-“Data n), a set of channel signal generators, and an adder. When using multi-level individual signals, sequences of binary data symbols can be divided into blocks to modulate individual signals; the set of n channel signal generators S₁, . . . , Sₙ. These non-orthogonal single channel signal generators, based on the “shift principles” shown above in FIGS. 2 and 3 and using the corresponding symbol blocks of the input sources combine with the adder that generates a common group channel signal as a sum of modulated individual non-orthogonal signals. The signals transmitted on the baseband channel can be subject to additive noise, which is inevitable in any physical environment.

The system further comprises a separating component. The separating component of the channels at the output of the group channel comprises a frequency-selective bandpass filter (BPF) configured to limit the effective spectrum of the signal-to noise mixture, an analog to digital converter (ADC) configured to transform the group signal into a digital form with a required sample rate. The channel signal generators at the transmit end and the ADC at the receive end operate under the control of the system clock to ensure synchronization. The synchronization system is not the subject of the present invention, and can be built in any known way, for example, in the same way as it is done for Synchronous Digital Hierarchy (SDH) systems.

The separating component further comprises an algebraic Solver-Separator (SS). The algebraic Solver-Separator (SS) employs a special algorithm and software configured to provide almost perfect discrimination of the signals of individual channels and protection against noise distortion. After detection and demodulation, the algebraic Solver-Separator (SS) distributes the decoded data to the appropriate subscribers.

The system for combining and separating non-orthogonal signals in multi-channel communication systems and multiple access systems comprises a channel forming component comprising a plurality of binary data sources, a set of non-orthogonal signal generators, and an adder. The system further comprises a separating component comprising a band pass filter, an analog-to-digital converter and a solver-separator. The separating component is configured to accept a group mixture from the channel forming component via a group channel with noise and provide a channel separation of the plurality of non-orthogonal signals.

The channel forming component is configured to generate a common group channel signal as a sum of modulated individual non-orthogonal signals. The band pass filter is a band pass selective filter configured to limit an effective spectrum of a signal-to noise mixture. The set of non-orthogonal signal generators and the analog-to-digital converter are controlled by a system clock.

The analog-to-digital converter is configured to transform a group signal into a digital form with a required sample rate. The solver-separator is in communication with the band pass filter and the analog-to-digital converter. The solver-separator is further configured to solve a system of linear algebraic equations based on a linear separating matrix.

A method for constructing and solving a special system of linear algebraic equations is used to generate an algebraic Solver-Separator (SS) and is described as follows. The method comprises providing a channel forming component comprising a plurality of binary data sources, a set of non-orthogonal signal generators, and an adder. Next, the method provides a separating component comprising a band pass filter, an analog-to-digital converter and a solver-separator. The method then divides a plurality of sequences of binary data symbols into a plurality of symbol blocks to modulate individual signals. Next, the method combines the plurality of symbol blocks with the adder to generate a common group channel signal as a sum of the modulated individual non-orthogonal signals. The method continues by limiting an effective spectrum of a signal-to noise mixture with the band pass filter. The method then uses the solver-separator to provide a discrimination of the signals of individual channels protected against noise distortion. The method further comprises synchronizing the set of non-orthogonal signal generators and the analog-to-digital converter with a system clock. The solver-separator is configured to solve a system of linear algebraic equations based on a linear separating matrix. After detection and demodulation, the algebraic Solver-Separator distributes the decoded data to the appropriate subscribers.

Assume that the entire transformation of each carrier of individual signals (without using an unknown information modulation parameter) SF₁(t), . . . SFₙ(t) after passing through the BPF is known and can describe it analytically SF₁(t) . . . SFₙ(t). It is not difficult to do this if we know the transfer function of the BPF is known. According to the principle of superposition, the transformation of each partial signal Sⱼ at the output of the BPF can be considered as a transformation of the only one without taking into account the others. This may be written as an expression for one measurement of the output signal of the group channel, performed by the ADC at an arbitrary point in time t:

$$SF ( {t}_{i} ) = {z}_{o} \cdot {SF}_{1} ( {t}_{i} ) + {z}_{1} \cdot {SF}_{2} ( {t}_{i} ) + … + {z}_{n - 1} {SF}_{n} ( {t}_{i} ) + NF ( {t}_{i} ) , \qquad Equation ( 9 )$$

where NF(tᵢ) is the unknown random value of channel noise after BPF filtering at the moment tᵢ; SF(tᵢ) is the known signal-to noise mixture measurement made by ADC; SF₁(tᵢ), . . . , SFₙ(tᵢ) are values of etalon form-factors of individual signals calculated by an analytical way in the time point tᵢ; and Z={z₀, z₁, . . . , zₙ₋₁} is the vector of desired unknown informative parameters, with the help of them data is transmitted.

To solve the problem of the detection of individual channel signals it suffices to find the vector Z whose coordinates uniquely determine the informative parameters corresponding to the blocks of symbols transmitted through these channels.

However, Equation (9) contains only one uncertainty in the form of term NF(tᵢ), which corresponds to the measurement of an unknown implementation of random noise that has passed through the BPF at time tᵢ. To eliminate this uncertainty, it suffices to understand that even if the noise has an unknown form and an arbitrary spectrum, after BTF processing, the frequency-limited noise can be represented by a Fourier expansion with a strictly limited number of harmonics. So, Equation (9) can be rewritten in the view:

$${\sum }_{k = 1}^{n} {z}_{k - 1} \cdot {SF}_{k} ( {t}_{i} ) + {\underbrace{{\sum }_{k = 0}^{M} {z}_{k + n} \cdot cos ( 2 π \cdot \frac{k}{d} \cdot {t}_{i} ) + {\sum }_{k = 1}^{M} {z}_{k + M + n} \cdot sin ( 2 π \cdot \frac{k}{d} \cdot {t}_{i} )}}_{Fourier expansion of the NF ( {t}_{i} )} = SF ( {t}_{i} ) , \qquad Equation ( 10 )$$

where M is the upper harmonic noise decomposition; d≥T is the Fourier decomposition period, which must at least the duration of the observation interval of the group channel T (to defend from Gibbs effect); zₖ₊ₙ, . . . , z_{M+n} are spectral coefficients of cosine quadratures of the Fourier approximation of the noise implementation, and z_{M+n+1}, . . . , z_{2M+n} are spectral coefficients of sine quadratures.

Equation (10), when comparison with Equation (9), is freed from the uncertainty of the unknown implementation of the noise NF(tᵢ) at the BPF output. But as a payment for this we already have (2·M+n+1) desired variables (coordinates of the vector Z). The first part of these variable z₀, . . . , zₙ₋₁, after their finding, determine encoded information symbols at the n outputs of individual channels, and the second part zₙ, . . . , z_{2M+n}—coefficients of the best Fourier decomposition of unknown noise realization.

To obtain a well-determine System of Linear Algebraic Equations (SLAE), which comprises Equation (10), N measurements at the ADC output are needed (where N≥(2·M+n+1)). Measurements performed at the time points t₀, t₁, . . . , t_{N-1} placement into interval T. To achieve the most accurate solution, requirement N>>(2·M+n+1) must be satisfied. In this case we will have overdetermine SLAE:

$$A \cdot Z = B \qquad Equation ( 11 )$$

The system (11) has N equations and (2·M+n+1) desired variable to finding. Matrix A usually is rectangular and has dimensions N×(2·M+n+1).

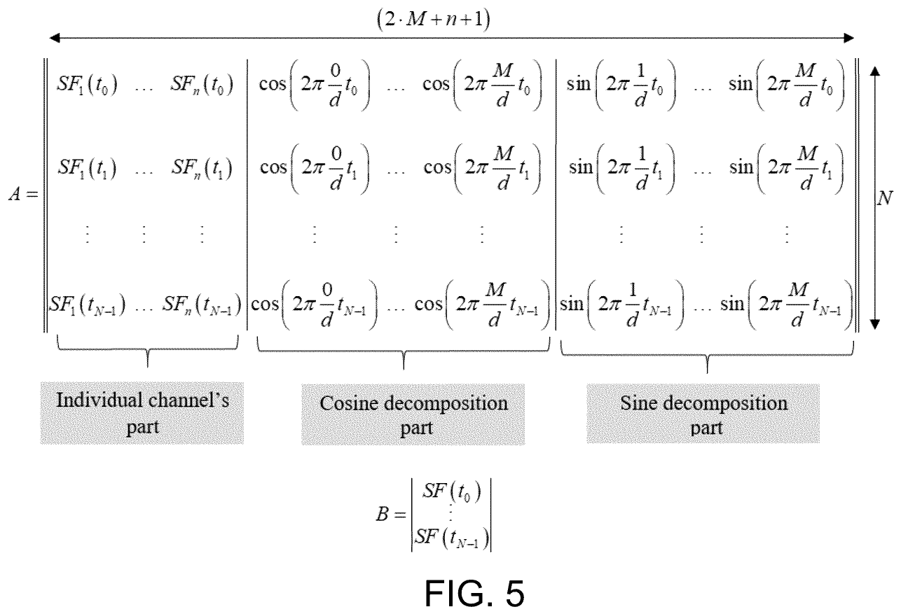

The matrix of the coefficients at the unknown variables A and the matrix-column of free terms B have a structure as illustrated in FIG. 5. The fundamental difference between the matrix and the closest prototypes (Equations 10 and 11) is the addition of (n−1) columns to some of the individual channels. This means an increase in the number of variables to be found. The overdetermined system or Equation (11) can be solved by orthogonal QR decomposition method or by an approximating least square method.

It is extremely important to note that all possible errors of the proposed method and system when extracting informative symbols of individual signals from the group channel caused only rounding errors when solving a rather cumbersome system of Equation (11) and errors introduced by ADC quantization noise. This fact makes the multichannel system of the present invention practically insensitive to the signal-to-noise ratio in the group channel.

The system of the present invention is further illustrated in examples of two specific computational experiments, which made it possible to evaluate the efficiency and noise immunity of the proposed solution.

### Example 1: Multi-Channel System Based on the Differences in the Start Time Moment of Signals (Time-Shift (TS) Method)

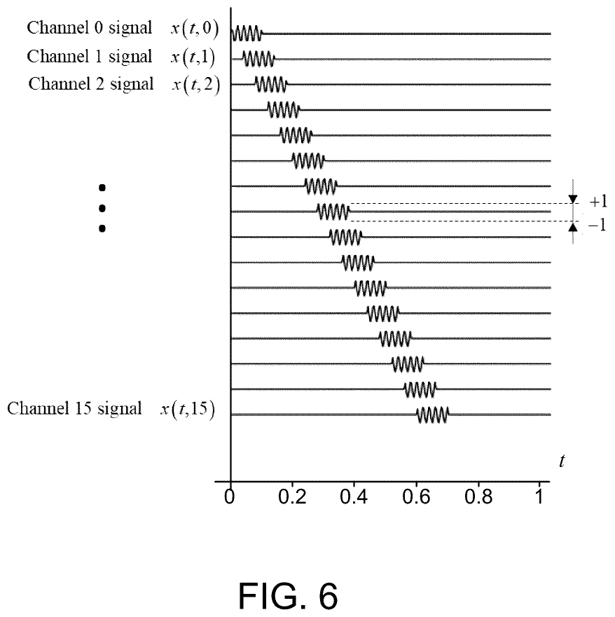

Example 1 considers a multi-channel communication system that makes it possible to transmit data from 16 independent sources practically without a large expansion of the required frequency-time resource at an arbitrary small signal-to-noise ratio in the group channel. Illustrations of the experimental steps are shown in FIGS. 6-14.

To simplify the consideration, we assume that the sampling frequency f_{D} of the ADC when processing the group signal is f_{D}=8000 Hz. So, below we will use a primitive time quantum equal to 1/8000 of a second to measure time. In the each individual channel we use carrier signal described by the formula:

$$Equation ( 12 )$$

$$x ( t , k ) = \{ \begin{matrix}{a}_{k} cos ( 2 π {f}_{c} t ) , & if k \cdot \frac{K}{8000} \leq t \leq k \cdot \frac{K}{8000} + Δ t ; \\ 0 & otherwise .\end{matrix} , k ∈ 0 …15 ,$$

where f_{c} is carrier frequency; Δt is signal duration; aₖ is the amplitude coefficient for encoding information, and

$$\frac{K}{8000}$$

is the value specifying the time offset between two adjacent channel signals.

If f_{c}=50 [Hz], Δt=0.1 [s], K=320 and aₖ=1 for any k∈0 . . . 15, then a set of individual signals will have a view shown in FIG. 6. It not difficult to note that each signal overlaps on the ⅔ of its duration with two neighbors one. In other words, these signals are mutually non-orthogonal since these are harmonic oscillations with the same phase.

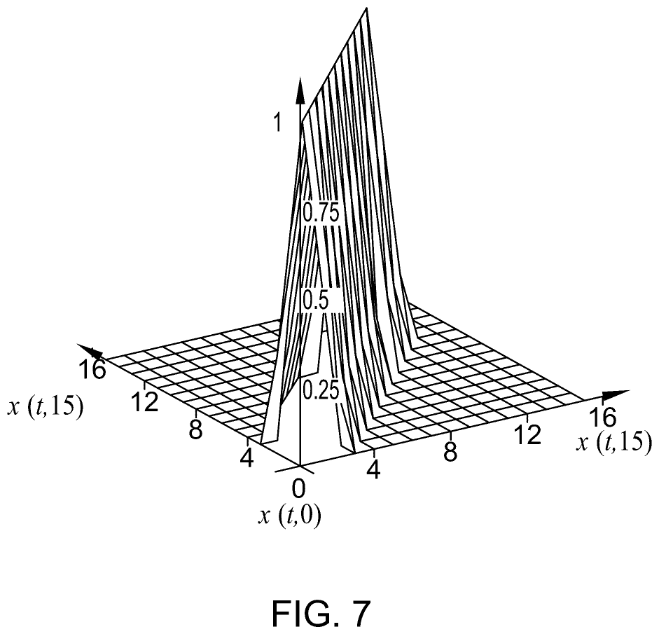

FIG. 7 illustrates a three-dimensional illustration of the values of the cross-covariance matrix CCM of a set of signals:

$$CCM = ‖ {ccm}_{i , j} ‖ , {ccm}_{i , j} = {\int }_{0}^{1} x ( t , i ) \cdot x ( t , j ) dt \cdot {[ {\int }_{0}^{1} {x ( t , i )}^{2} dt ]}^{- 1} , i , j ∈ 0 , … , 15 \qquad Equation ( 13 )$$

To encode data in each individual signal (channel), we will use 16 different amplitude values aₖ in the range from −1 to +1, calculated according to the rule:

$${a}_{k} = - 1 + \frac{2 \cdot k}{15} , k = 0 , 1 , … , 15. \qquad Equation ( 14 )$$

This means that each elementary signal on a separate channel carries Nb=4 bits of data from its own source. If we consider the values of Equation (14) as a measurement in volts, then we can determine the average energy value per transmitted bit in each individual channel by the following expression:

$${E}_{b} = \frac{1}{Nb} {\int }_{0}^{1} {[ {σ}_{a} x ( t , k ) ]}^{2} dt for any k ∈ 0 , … , 15 , \qquad Equation ( 15 )$$

where

$${σ}_{a} = \sqrt{\frac{1}{{2}^{Nb}} {\sum }_{i = 0}^{{2}^{Nb} - 1} {( - 1 + \frac{2 \cdot i}{{2}^{Nb} - 1} )}^{2}}$$

is amplitude standard deviation (follows from Equation (14)).

The additive noise acting in the group channel can be described by the following Fourier expansion:

$$Equation ( 16 )$$

$$N ( t ) = {\sum }_{i = 0}^{{F}_{N} \cdot {T}_{N}} {nc}_{i} \cdot cos ( 2 π \frac{i}{{T}_{N}} t ) + {\sum }_{i = 0}^{{F}_{N} \cdot {T}_{N}} {ns}_{i} \cdot sin ( 2 π \frac{i}{{T}_{N}} t ) , t ∈ {T}_{N} ,$$

where ncᵢ, nsᵢ are normally distributed with standard deviation σ_{N} random variables; F_{N} is the highest frequency in the noise spectrum; T_{N} is the period of noise decomposition. To avoid the singularity of the noise model of Equation (16), the value T_{N} should be chosen much larger than the signal analysis interval. If we want to simulate a situation where the signal-to-noise ratio (per bit transmitted) is

$${h}_{N} = \frac{{E}_{b}}{{N}_{0}} ,$$

the value σ_{N} can be calculated as follows:

$${σ}_{N} = \sqrt{\frac{{E}_{b}}{2 \cdot {T}_{N} \cdot {h}_{N}}} , \qquad Equation ( 17 )$$

then the noise spectral density N₀ in the frequency band F_{N} when using Equation (16) is determined by the formula:

$${N}_{0} = 2 \cdot {T}_{N} \cdot {σ}_{N}^{2} . \qquad Equation ( 18 )$$

The group channel signal is formed as a sum of 15 individual signals modulated by values aₖ:

$$X ( t ) = {\sum }_{k = 0}^{15} {a}_{k} \cdot x ( t , k ) . \qquad Equation ( 19 )$$

The addition of noise in the group channel leads to the observation of the next mixture at the BPF input:

$$Y ( t ) = X ( t ) + N ( t ) . \qquad Equation ( 20 )$$

We will consider a case when BPF is the totally linear device. This fact enables us to use the principle of superposition and analyze the process of passage of additive components of Equation (20) Y(t) separately with subsequent summation of the resulting responses.

Let the BPF be described as an 8th order resonant filter with a center frequency equal to f_{c}=50 Hz. The BPF transfer function has the form:

$$W ( s ) = \frac{1}{300 \cdot {T}^{8}} \cdot \frac{1}{( {s}^{2} + {α}_{1} s + δ ) ( {s}^{2} + {α}_{2} s + δ ) ( {s}^{2} + {α}_{3} s + δ ) ( {s}^{2} + {α}_{4} s + δ )} , \qquad Equation ( 21 )$$

where s=jω is Laplace transform variable (complex frequency); ω is frequency

$$[ \frac{radian}{second} ] ;$$

j=\sqrt{−1} is an imaginary unit;

$$T = \frac{1}{2 π {f}_{c}}$$

is a time constant;

$$δ = {T}^{2} ; {α}_{1} = \frac{2 ξ 1}{T} , {α}_{2} = \frac{2 {ξ}_{2}}{T} , {α}_{1} = \frac{2 {ξ}_{3}}{T} , {α}_{1} = \frac{2 {ξ}_{4}}{T} ; {ξ}_{1} = 0.15 , {ξ}_{2} = 0.13 , {ξ}_{3} = 0.11 , {ξ}_{4} = 0.1$$

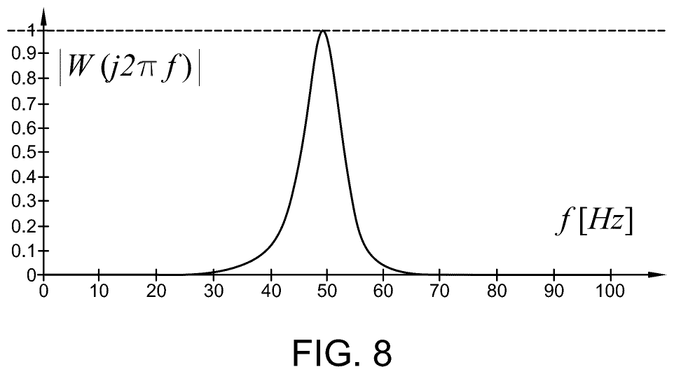

are attenuation coefficients of four BPF stages; the number 300 in the denominator of Equation (21) is used to normalize the amplitude characteristic at the resonant frequency f_{c} to 1. In FIG. 8 the BPF frequency response |W(j2πf)| is shown. BPF is used to suppress out-of-band (in relation to the carrier frequency f_{c} of individual signals) components of the channel noise.

The frequency response of the FBF |W(j2πf)| can be calculated for the harmonics included in the Fourier noise expression of Equation (16). As a result, we obtain the array of the amplitude coefficients:

$${ε}_{i} = \vert W ( j \cdot 2 π \frac{i}{{T}_{N}} ) \vert , i ∈ 0 , 1 , … , ( {F}_{N} \cdot {T}_{N} ) \qquad Equation ( 22 )$$

So, if we have noise (16) at the BPF input, then after passing through the BPF it can be described as follows:

$$N F ( t ) = {\sum }_{i = 0}^{{F}_{N} \cdot {T}_{N}} {ε}_{i} \cdot {nc}_{i} \cdot cos ( 2 π \frac{i}{{T}_{N}} t ) + {\sum }_{i = 0}^{{F}_{N} \cdot {T}_{N}} {ε}_{i} \cdot n {s}_{i} \cdot sin ( 2 π \frac{i}{{T}_{N}} t ) , t ∈ {T}_{N} . \qquad Equation ( 23 )$$

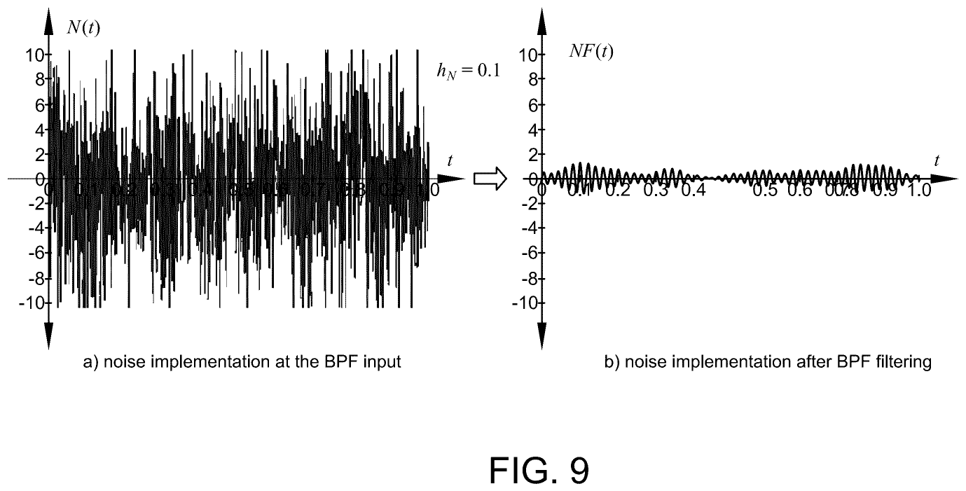

This expression totally correct describes passing the stationary noise through BPF and saves the random phases distribution. In other words, we absolutely know exactly what will happen with to the noise after BPF filtering. To illustrate this conversion when F_{N}=1000 [Hz], T_{N}=2 [s] and signal-to-noise ratio h_{N}=0.1, in FIG. 9 corresponding diagrams are shown.

To find the forms of signal transformation performed by the BPF, we use the impulse function and the convolution integral. The impulse function BPF can be defined as the inverse Laplace transform of the transfer function w(t)=L⁻¹[W(s)].

$$Equation ( 24 )$$

$$w ( t ) = \frac{1}{300} {\sum }_{k 1}^{4} \{ [ {λ}_{k} cos ( t \cdot \sqrt{δ - \frac{{α}_{k}^{2}}{4}} ) + {μ}_{k} sin ( t \cdot \sqrt{δ - \frac{{α}_{k}^{2}}{4}} ) ] exp ( - \frac{{α}_{k}}{2} t ) \} .$$

The coefficients λₖ, μₖ, included into Equation (24), were calculated by the method of indefinite factors using the expansion of equation (21) into the simple fractions and are presented in Table 1.

TABLE 1

| λₖ | | μₖ | |
|---|---|---|---|
| λ₁ | −44669.520543229872608 | μ₁ | −21671.838902824829162 |
| λ₂ | 152563.59323995433414 | μ₂ | 62909.518196880094785 |
| λ₃ | −233557.77884031619107 | μ₃ | −80174.008386094534026 |
| λ₄ | 125663.70614359172954 | μ₄ | 38941.506142978742923 |

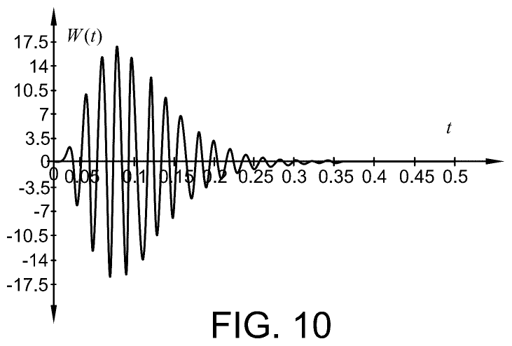

The w(t) form representing the BPF response to the Dirac delta function is shown in FIG. 10. Since function w(t) is known, we can use the convolution integral to find the BPF filtering result of the arbitrary signal. For example, filtering process of x(t,0) is describing follows:

$$x F ( t , 0 ) = {\int }_{0}^{t} w ( τ ) \cdot x ( t - τ , 0 ) d τ . \qquad Equation ( 25 )$$

However, this formula only is correct, if function x(t,0) has no breaks onto analysis interval (we will consider time slot from 0 to 1 second). Unfortunately, in our case the signal x(t,0) starts at the t=0 and breaks at the t=0.1 [s]. So, the expression of Equation (25) totally and exactly calculates the starting transient when the signal x(t,0) arrives at the input BPF, but absolutely false when the signal breaks. To solve this problem, we use the following representation for any individual signal from the set of Equation (12):

$$Equation ( 26 )$$

$$x ( t , k ) = \{ \begin{matrix}{a}_{k} [ cos ( 2 π {f}_{c} \cdot t ) - cos ( 2 π {f}_{c} \cdot ( t - Δ t ) ) ] , \\ 0\end{matrix} \begin{matrix}if t \geq k \cdot \frac{K}{8000} \\ if t < k \cdot \frac{K}{8000}\end{matrix} ; k ∈ 0 …15 .$$

In this representation we assume, that

$$Δ t = \frac{m}{{f}_{c}} ,$$

where m—integer, m=0, 1, . . . , that is Δt coincides with an integer number of complete periods of oscillation of the carrier frequency f_{c}. Now we introduce an auxiliary function of time:

$${x}^{*} ( t ) = Φ ( t ) \cdot cos ( 2 {πf}_{c} t ) , \qquad Equation ( 27 )$$

where Φ(t) is a Heaviside unit switching function.

This is oscillation of carrier frequency, which exists only on the positive time semi axis. Then, based on Equation (26), we can determine the BPF response to any signal from the set from Equation (12) as

$$\begin{matrix}XF ( t , k ) = xF ( t - k \cdot \frac{K}{8000} ) - xF ( t - Δ t - k \cdot \frac{K}{8000} ) , \\ where xF ( t ) = {\int }_{0}^{t} w ( τ ) \cdot x ( t - τ ) d τ .\end{matrix} \} \qquad Equation ( 28 )$$

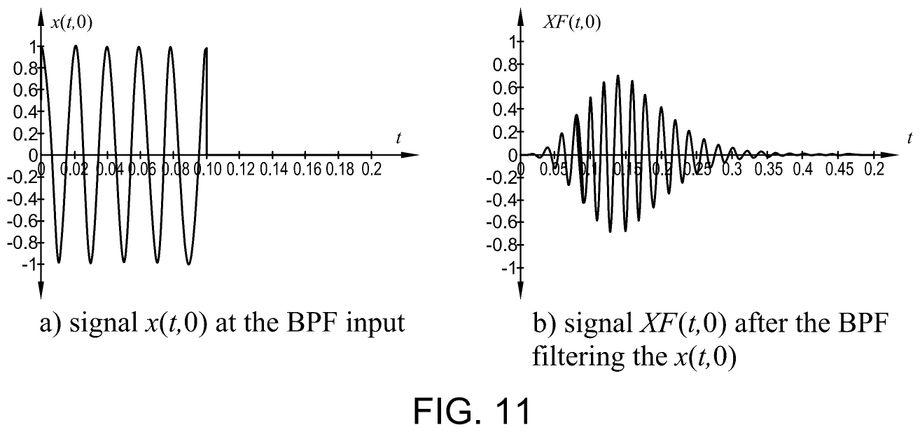

In FIG. 11 we illustrate BPF filtering process for signal x(t,0). There are some delay and two transient processes at the beginning and at the end of the signal x(t,0). Expressions (23) and (28) are the correct analytical model and completely describe filtering process for any individual signal (channel) and group channel noise. Thus, the result of filtering the signal/noise mixture is determined by the principle of superposition as the sum of individual BPF responses. The following process is available at the output of the BPF for ADC measurements:

$$YF ( t ) = {\sum }_{k = 0}^{15} {a}_{k} \cdot XF ( t , k ) + NF ( t ) . \qquad Equation ( 29 )$$

All of components included into Equation (29) were defined by expressions (23) and (28). Therefore, we can form the matrices A, B (see FIG. 5) and solve the system of Equation (11). For chosen sample rate f_{D}=8000 Hz of the ADC, we have:

$$A = ‖ {A}_{i , j} ‖ ; \qquad Equation ( 30 )$$

$${A}_{i , j} = XF ( \frac{i}{8000} , j ) , i ∈ 0 , 1 , … , {N}_{max} , j ∈ 0 , 1 , … , 15 ;$$

$${A}_{i , j} = cos ( 2 π \frac{j - 16}{d} \cdot \frac{i}{8000} ) , i ∈ 0 , 1 , … , {N}_{max} , j ∈ 16 , 17 , … , ( M + 16 )$$

$${A}_{i , j} = sin ( 2 π \frac{j - 16}{d} \cdot \frac{i}{8000} ) , i ∈ 0 , 1 , … , {N}_{max} ,$$

$$j ∈ ( M + 17 ) , ( M + 18 ) , … , ( 2 M + 16 ) .$$

$$B = ‖ {B}_{i} ‖ ; {B}_{i} = YF ( \frac{i}{8000} ) , i ∈ 0 , 1 , … , {N}_{max} . \qquad Equation ( 31 )$$

Here Nₘₐₓ is the maximal number of samples used in our chosen analysis time interval.

The results of a statistical verification of the computational model of the present invention are presented below. Before starting the model, the formation of the matrix of Equation (30) is performed, since this matrix does not change from step to step of the experiment. The statistical test include the following steps. First, is the generation of a vector of uniformly distributed modulating amplitude coefficients aₖ including 16 randomly selected values each of which takes one of the possible values from range:

$${a}_{k} ∈ [ - 1 , - \frac{13}{15} , ⋯ , - \frac{1}{15} , \frac{1}{15} , ⋯ , \frac{13}{15} , 1 ] . \qquad Equation ( 32 )$$

These values uniquely determine 16 blocks of bits, each of them consists of 4 bits transmitted through corresponding subchannel in the group channel. When the modulation performs by multiplying the aₖ values by the corresponding carrier signal, it is fair to count that each individual signal carries 4 information bits.

The next step is the generation of a two random sets of normally distributed (with zero mean and standard deviation that determines the required value of the signal-to noise ratio) Fourier-coefficients nc, ns and the formation a noise implementation NF(t) at parameters values F_{N}=1000 Hz, T_{N}=2 s. It means that the noise bandwidth is ten times wider than the effective spectrum of the signal in the group channel;

The next step is the formation of a mixture signal of a group channel+implementation of noise YF(t) based on Equation (29).

The next step is the formation of an array of ADC measurements of YF(t) based on Equation (31). In this stage it is extremely important to take into account the limited bit depth of the ADC. This limitation is a source the most dangerous kind of noise for the present invention, the quantization noise. Quantization errors arise when measuring an already filtered by BPF process. The quantization noise has an infinite spectrum and critically affects the stability of the solution of the system of Equation (11) with the matrix A designed to interpolate and eliminate noise with a strictly limited spectrum. Moreover, the right choice of the dynamic range of the ADC input D is needed. If a value D is exceeded, the clipping limitation of measurements also destroys the stability of the solution. For these reasons to achieve a correct result of the experiment we use next analytical model of ADC measurement [symbol] (tᵢ) in time point tᵢ based on the true value of

$$YF ( {t}_{i} ) : {YF}^{Δ} ( {t}_{i} ) = \{ \begin{matrix}D \cdot \{ {2}^{- ( nb - 1 )} \cdot ⌊ \frac{( YF ( {t}_{i} ) + D ) \cdot {2}^{nb - 1}}{D} ⌋ + {2}^{- nb} - 1 \} , & if - D ( 1 - {2}^{- nb} ) \leq YF ( {t}_{i} ) \leq D ( 1 - {2}^{- nb} ) \\ D ( 1 - {2}^{- nb} ) , & if YF ( {t}_{i} ) > D ( 1 - {2}^{- nb} ) ; \\ - D ( 1 - {2}^{- nb} ) , & if YF ( {t}_{i} ) < - D ( 1 - {2}^{- nb} ) .\end{matrix} \qquad Equation ( 33 )$$

where nb is a bit depth of ADC; D is the dynamic range of ADC measurements, which must be chosen not less than maximum absolute value of the signal-to-noise mixture YF(t) in the signal analysis time interval. The second and third rows of Equation (33) take into account not only quantization error, but possible clipping errors too. So, based on Equation (33) the matrix-column B formation procedure can be described follows;

$$B = ‖ {B}_{i} ‖ ; {B}_{i} = {YF}^{Δ} ( \frac{i}{8000} ) , i ∈ 0 , 1 , … , {N}_{max} . \qquad Equation ( 34 )$$

The next step is based on formed matrices of Equations (30), (34) where we perform solving system Equation (11) and find desired values of the vector of unknown variables Z. Values of the first elements of the vector Z′=z₀, z₁, . . . , z₁₅ determines and estimates the signals modulation coefficients for all individual channel. Rounding these estimates to the nearest acceptable value from the range from Equation (32) uniquely determines the block of 4 bits transmitted in each of the channels. In this example, the issues of normalizing the amplitude scale of the input circuit of the receiver are omitted by us.

The next step is counting the number of mismatches between transmitted and received bits on all individual channels and collect data to calculate the bit error rate (BER). Finally, the steps are repeated until the required statistical volume is reached.

During verification modelling process was used parameter Nₘₐₓ=8000÷12000. That is, to receive a group signal with a duration of less than 1 s., it was necessary to carry out measurements in the time interval of 1÷1.5 s. Measurement redundancy is necessary to create an overdetermined system of Equation (11) to reduce the negative impact of quantization noise. Results of the experiment show that accuracy of the reception and amplitude group demodulation, practically does not depend from signal-to-noise ratio in the group channel, but significantly depend on bit depth of the ADC.

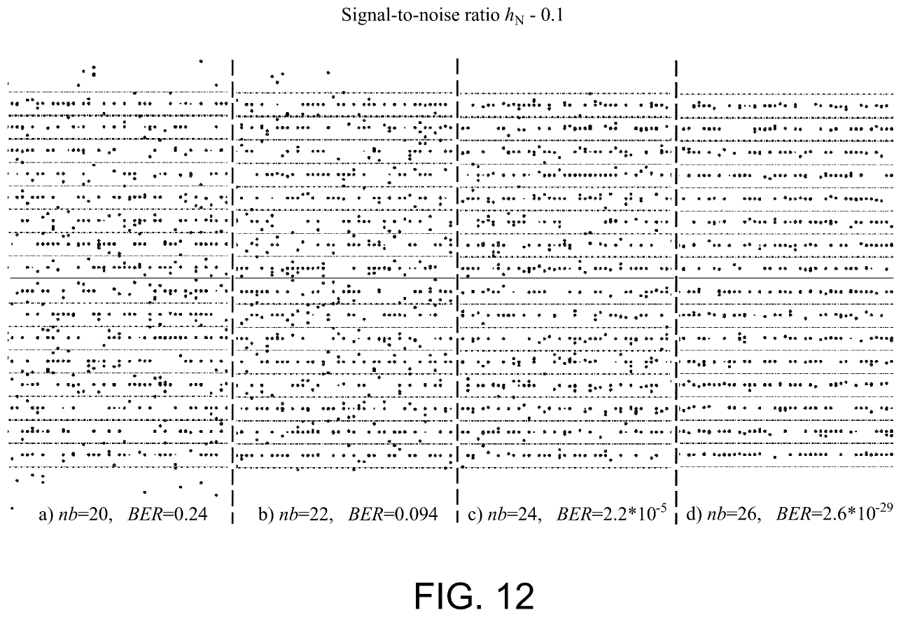

In FIG. 12 statistical testing results are shown obtained at signal-to-noise ratio h_{N}=1 per transmitted bit in the group channel. We used four ADC bit depth from 20 to 26 bits per measurement. For each bit depth, the BER parameter was calculated, which varied from 0.24 to 2.6·10⁻²⁹. It is important to note, that the best-known methods of signal reception based on the maximum likelihood rule give value BER≈0.078. It is quite enough to choose an ADC with more than 24 bits to significantly improve the known results. This fact fully testifies to the achievement of one of the main goals of the invention—a significant increase in the noise immunity of the group channel.

In FIG. 12 for clarity of the results shows a graphical illustration of the offset values of the demodulated amplitude (points in the figure). The boundaries between the nearest vertical acceptable amplitude levels are shown by dotted lines. With an increase in the bit depth of the ADC, almost the disappearance of the points shift and the absolute accuracy of reception are achieved. To calculate of too small probability value BER, when we did not observe any bit error (see, for example, FIG. 12), we used a probabilistic integral:

$$BER \approx \frac{2}{σ \sqrt{2 π}} [ {\int }_{Δ}^{3 Δ} exp ( - \frac{x}{2 {σ}^{2}} ) dx + 2 {\int }_{3 Δ}^{5 Δ} exp ( - \frac{x}{2 {σ}^{2}} ) dx ] , \qquad Equation ( 35 )$$

where σ is the standard deviation of point displacement from the true amplitude level, calculated during the experiment;

$$Δ = \frac{1}{{2}^{Nb} - 1}$$

is a value equal to half the distance between adjacent permissible amplitude levels from the range of Equation (32). Expression (35) assumes the use of the Gray keying code in the amplitude coding of blocks of 4 bits when modulating each of the individual signals. This means that if the point is shifted by one level, then only one bit of data will be erroneous, a shift by two levels leads to the fact that an error occurs in two bits. In this case we restrict to only two levels of possible biases due to the extremely small probability of large values.

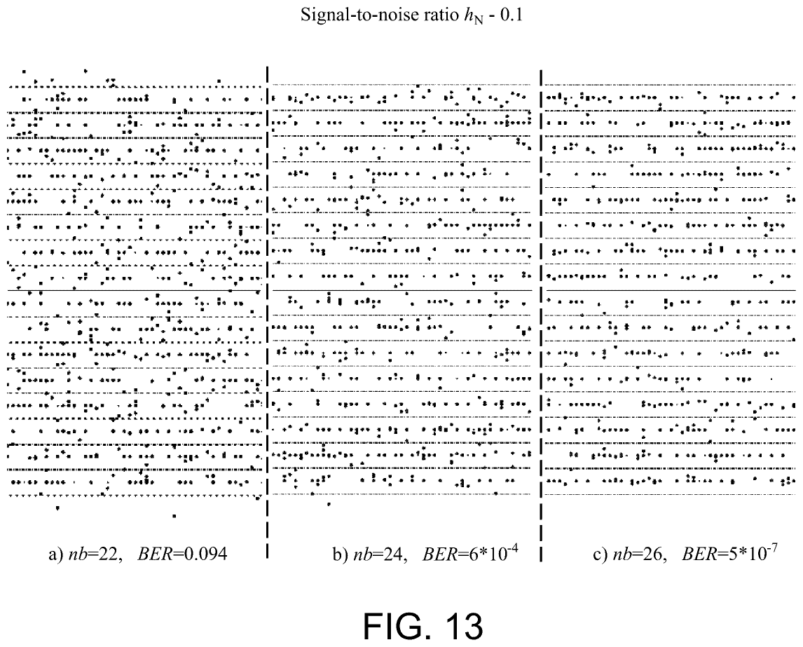

FIG. 13 illustrates statistical testing results obtained at signal-to-noise ratio h_{N}=0.1 per transmitted bit in the group channel (this is an extremely low value at which no existing system can operate). Result shows us, that enough choice ADC bit depth equal 26 to achieve practically zero BER. This statement once again confirms the achievement of the goal of a sharp increase in noise immunity.

Now the gain achieved by reducing the frequency-time resource of the group signal can be evaluated by making a comparison with the TDMA method. When using TDMA for given set of individual signals illustrated in FIG. 6, we would need channel usage time: T_{TDMA}>16·Δt=1.6 [s] (excluding guard intervals). In fact, in the example above (time-shift (TS) method), we use time as:

$${T}_{TS} = Δ t + 15 \cdot \frac{2}{5} \cdot Δ t = 7 \cdot Δ t .$$

Therefore, we have a time gain as follows:

$${Gain}_{T} = \frac{16}{7} = 3.2 times . \qquad Equation ( 36 )$$

To understand what happened to the signal spectrum in the group channel when using the TS method, a mathematical description of the spectrum of repetitive signals is considered. We can get a formula for calculating the complex spectrum of a sequence of time-shifted signals using the delay theorem and the superposition principle, which are valid for linear transformations. We assume that one elementary signal has a complex spectrum G(jω). Then the sequence of n such signals shifted in the time by value τ will have the spectrum:

$$Gn ( j ω ) = {\sum }_{k = 0}^{n} G ( j ω ) \cdot {e}^{- jk ωτ} = G ( j ω ) \cdot [ {\sum }_{k = 0}^{n} Cos ( k \cdot ω \cdot τ ) - j {\sum }_{k = 0}^{n} Sin ( k \cdot ω \cdot τ ) ] .$$

We assume that n is an even number and denote

$${ω}_{p} = \frac{2 π}{τ} ,$$

then:

$$Gn ( j ω ) = G ( j ω ) \cdot {e}^{- j ω \frac{n}{2} τ} [ 1 + {\sum }_{k = 1}^{n / 2} ( {e}^{jk 2 π \frac{ω}{{ω}_{p}}} + {e}^{- jk 2 π \frac{ω}{{ω}_{p}}} ) ]$$

The multiplier

$${e}^{- j ω \frac{n}{2} τ}$$

does not affect the spectrum because it only delays the time by value

$$\frac{n}{2} τ .$$

### Then:

$$G n ( j ω ) = G ( j ω ) \cdot [ 1 + 2 \cdot {\sum }_{k = 1}^{n / 2} Cos ( k \cdot 2 \cdot π \frac{ω}{{ω}_{p}} ) ] = G ( j ω ) \cdot Θ ( ω , n ) . \qquad Equation ( 37 )$$

If n is large enough, then the factor Θ(ω,n) is degenerating into a periodic delta-function that strobes the original spectrum G(jω) with a period equal

$${ω}_{p} = \frac{2 π}{τ} .$$

So, the sequence of signal has a spectrum that cannot be wider than original one. For the rigor of the estimate and for comparison with TDMA, we will carry out an exact calculation of the amplitude spectrum of the group signal for the TS method.

Amplitude spectrum of a single signal, calculated for a time interval of 1 second:

$${G}_{T D M A} ( f ) = \vert \frac{1}{2 π} {\int }_{0}^{1} x ( t , 0 ) \cdot {e}^{- j 2 π f t} dt \vert . \qquad Equation ( 38 )$$

Amplitude spectrum of a group signal, calculated for the same time interval:

$${G}_{T S} ( f ) = \vert \frac{1}{2 π} {\int }_{0}^{1} [ {\sum }_{k = 0}^{15} x ( t , k ) ] \cdot {e}^{- j 2 π f t} dt \vert . \qquad Equation ( 39 )$$

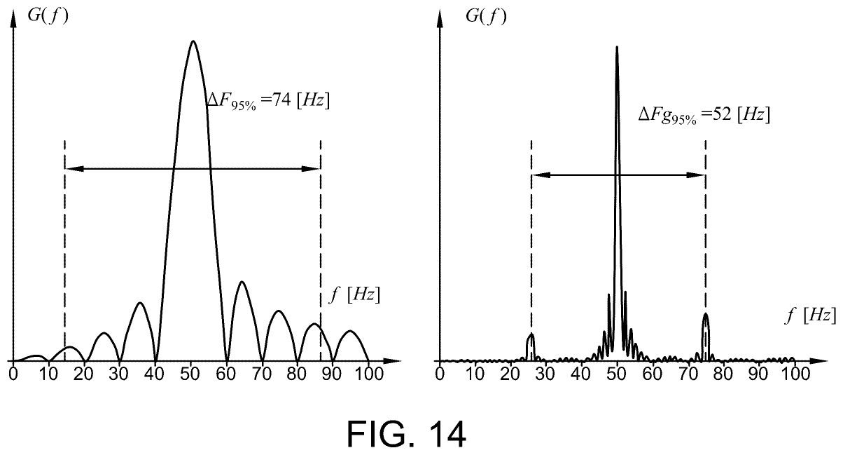

FIG. 14 shows the spectra from Equations (38) and (39) and presents the definitions of the calculation of the effective width of these spectra as a frequency band that includes 95% of the total signal energy. Confirmed by calculations from Equations (38), (39), the transformation of Equation (37) of the spectrum of the group signal, provided that the signals are superimposed in time, leads to an unexpected result. The frequency band of the group signal turns out to be less than the band of a single signal:

$${Gain}_{F} = \frac{Δ {F}_{95 \%}}{Δ F {g}_{95 \%}} \approx 1.4 times . \qquad Equation ( 40 )$$

Combining the results from Equations (36) and (40) gives the total gain of the TS method in the frequency-time resource of the group channel compared to TDMA:

$$Gain = {Gain}_{T} \cdot {Gain}_{F} > 4.5 times .$$

This definition confirms the second objective of the invention which is to achieve a significant reduction in the required time-frequency resource of the group channel. Thus, we achieve a significant increase in noise immunity and, accordingly, a significant reduction in the frequency-time resource.

### Example 2: Multi-Channel System Based on the Combined Method of Time-Shift (TS) and Duration-Change (DC)

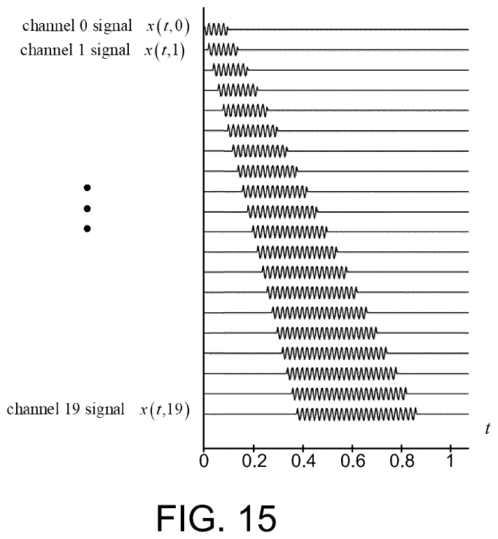

Additional opportunities to increase the effectiveness of multi-channel systems based on different features of signal separating when joining usage of a few methods. Let's consider a combined method for constructing a group channel based on time-shift and duration-change protocols; the TS-DC-method. Illustrations of the experimental stages are shown in FIG. 15-18.

Our consideration will be shorter since conditions of the computational experiment do not change. The combination of methods makes it possible to increase the specific efficiency of multi-channel systems and the specific information transfer rate, as well as to reduce the requirements for the ADC bit depth. To construct the group channel, we use the set of individual signals shown in FIG. 15. The basic shape of the signals is the same as in previous example, but their timing and duration are various:

$$x ( t , k ) = \{ \begin{matrix}{a}_{k} cos ( 2 π {f}_{c} t ) , & if k \cdot \frac{{K}_{1}}{8000} \leq t \leq k \cdot \frac{{K}_{2}}{8000} + Δ t ; \\ 0 & otherwise\end{matrix} . , \qquad Equation ( 41 )$$

$$k ∈ 0 … 19.$$

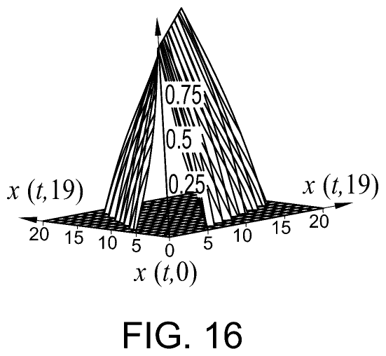

In the FIG. 15 were used next parameters: f_{c}=50 Hz, K₁=160, K₂=320. The zero-channel signal includes 5 periods of oscillations of the carrier frequency f_{c}. Each of the following signals is delayed by one period and extended by two periods. Note that the signal set now consists of 20 different individual signals forming separate channels. The signal set is non-orthogonal. FIG. 16 illustrates a three-dimensional illustration of the values of the cross-covariance matrix of a set of the TS-DC method signals. Comparison of the images in FIG. 7 and FIG. 16 indicates that the TS-DC-method signals are more cross-correlated than the TS-method signals. Therefore, we have the right to expect a more significant reduction in the required time-frequency volume of the group channel. Despite the increased correlation, the use of two channel separation features makes it possible to increase the number of bits transmitted by each individual signal. Now we will assume the transmission of Nb=5 bits by each signal, so for data encoding we will use 32 different amplitude values aₖ in the range from −1 to +1, calculated according to the rule:

$${a}_{k} = - 1 + \frac{2 \cdot k}{31} , k = 0 , 1 , … , 31. \qquad Equation ( 42 )$$

To calculate the energy parameters of the group channel, expression (15) can be used under the condition Nb=5. Estimation of the required time-frequency resource and comparison with the TDMA-method gives following results. To transmit signals set from Equation (41) by TDMA-method excluding guard intervals, it is necessary to build the 20 signals of set from Equation (41) in a serial chain, which will require the following amount of time for using the group channel:

$${T}_{TDMA} > {\sum }_{k = 0}^{19} ( 0.1 + k \cdot 0.04 ) = 9.6 [ s ] , \qquad Equation ( 43 )$$

while the usage of the TS-DC-method requires:

$${T}_{TS - D C} > 0.1 + 19 \cdot 0.04 = 0.86 [ s ] \qquad Equation ( 44 )$$

$$So ,$$

$${Gain}_{T} > \frac{9.6}{0.86} \approx 11.2 times . \qquad Equation ( 45 )$$

Both the TDMA and TS-DC methods require the same frequency band:

$${G}_{T D M A} ( f ) = \frac{1}{2 π} \vert {{\sum }_{k = 0}}^{19} {{\int }_{0}}^{1} x ( t , 0 ) \cdot {e}^{- j 2 π f t} dt \vert = \frac{1}{2 π} \vert {{\int }_{0}}^{1} {e}^{- j 2 π f t} \cdot {\sum }_{k = 0}^{19} x ( t , 0 ) dt \vert = {G}_{TS - D C} ( f ) . \qquad Equation ( 46 )$$

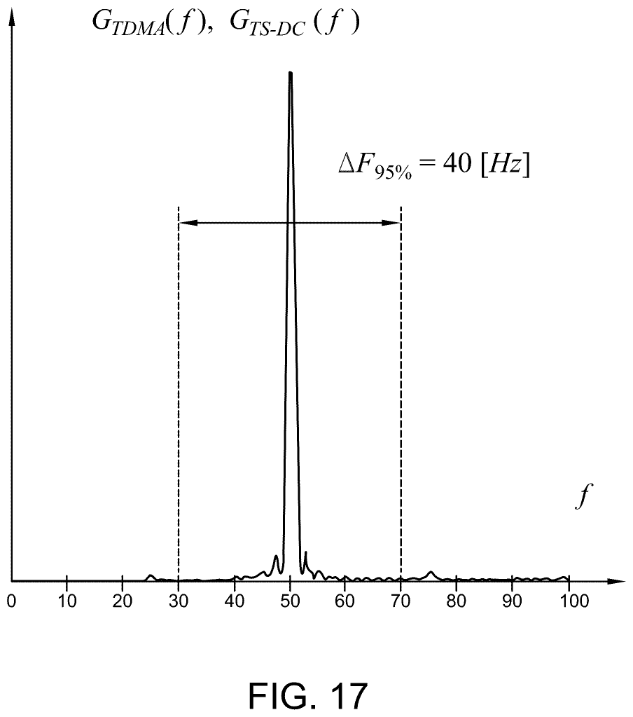

The normalized spectrum from Equation (46) and the definition of the effective bandwidth is shown in FIG. 17. Therefore, total gain of the TS-DC-methods in the required time-frequency volume is:

$$Gain = {Gain}_{T} > 11.2 times . \qquad Equation ( 47 )$$

This value, is about two times greater, than for the simple TS-method.

At a 95% energy level, the group channel requires about 40 Hz of the bandwidth. Note, that in this bandwidth with help TS-DC method during the 0.86 second 5×20=100 bits of a data are transmitted. Specific rate of information transfer is about

$$3 [ \frac{bit / second}{Hz} ] .$$

This value exceeds the Nyquist limit, and TDMA, FDMA and CDMA systems require a huge specific energy costs for such speeds. The TS-DC-method, on the contrary, has a huge energy reserve.

To evaluate the noise immunity and the required bit depth of the ADC for the TS-DC-method, an experiment was carried out using the same noise model, BPF and digitization process as in the previous example. When forming matrix A (30), in this experiment the following definition of the resulting BPF filtering a single signal from set (41) was used:

$$\begin{matrix}XF ( t , k ) = xF ( t - k \cdot \frac{{K}_{1}}{8000} ) - xF ( t - Δ t - k \cdot \frac{{K}_{2}}{8000} ) , \\ where xF ( t ) = {{\int }_{0}}^{t} w ( τ ) \cdot {x}^{*} ( t - τ ) d τ\end{matrix} . \} . \qquad Equation ( 48 )$$

Verification vas carried out when

$${h}_{N} = \frac{{E}_{b}}{{N}_{0}} = 0.1$$

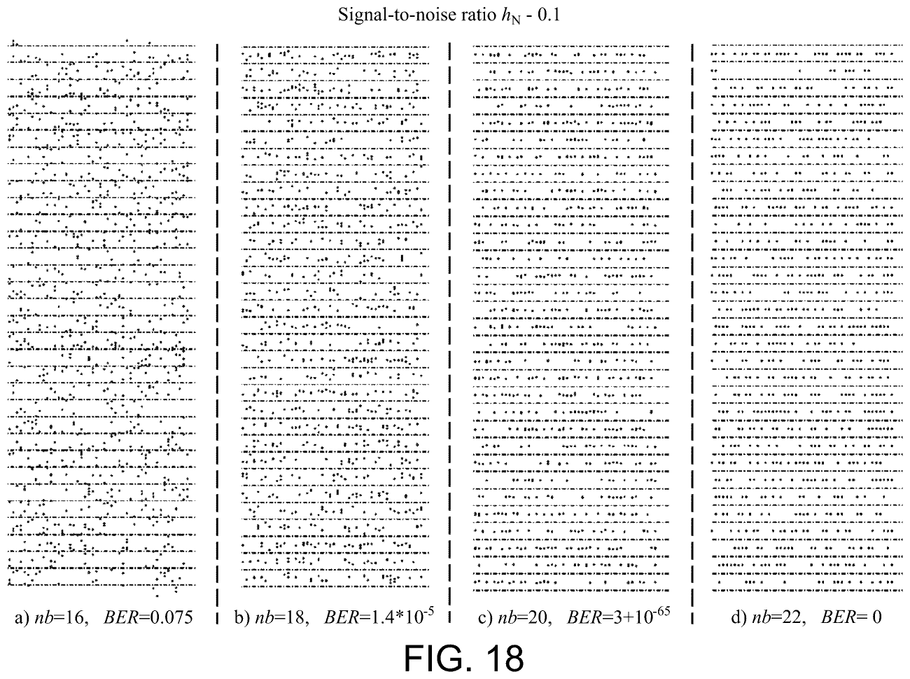

is extremely low. Results of the TS-DC-method testing are shown in FIG. 18. The diagram consists of images that show the scatter of points when making estimates of the true transmitted value of the amplitudes of individual signals. Under conditions of this experiment amount of acceptable amplitude values was two times greater, then in the previous experiment, and equal to 32. Respectively the mutual distances between their in the same amplitude range is two times less. Despite to negative factors above, the TS-DC-method is achieving the better results. As we can see in FIG. 18, almost zero BER was obtained with an ADC of 20 bits, which is much less than the simple TS-method can provide.

The materials considered above and computational experiments fully confirm the stated goals of a significant reduction in the required frequency-time resource of the group channel of multichannel systems, as well as a significant increase in noise immunity. These advantages are achieved by ensuring accurate synchronization of the receiver and transmitter and with the appropriate bit depth of the receiver's ADC. These requirements are a very reasonable price to pay for obtaining a systems which provide operation at speeds far in excess of the erroneously canonicalized so-called “Capacity”.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system for combining and separating a plurality of non-orthogonal signals in a multi-channel communication system comprising:
a transmitting side comprising a set of non-orthogonal signal generators and an adder; and
a receiving side comprising a band pass filter, an analog-to-digital converter and a solver-separator; and
wherein the receiving side is configured to accept a group mixture from the transmitting side via a group channel with noise and provide a channel separation of the plurality of non-orthogonal signals.

2. The system of claim 1, wherein the set of non-orthogonal signal generators is modulated by a block of bits from an information source.

3. The system of claim 1, wherein the set of non-orthogonal signal generators and the adder are configured to generate the group channel.

4. The system of claim 1, wherein the system is configured to reduce a required frequency-time resource of the group channel of the multichannel system.

5. The system of claim 1, wherein the system is configured to provide an increase in noise immunity.

6. The system of claim 1, wherein the set of non-orthogonal signal generators are controlled by a system clock.

7. The system of claim 1, wherein the analog-to-digital converter is controlled by a system clock.

8. The system of claim 1, wherein the solver-separator is configured to provide a discrimination of a plurality of signals of individual channels and protection against noise distortion.

9. The system of claim 1, wherein the solver-separator is configured to distribute decoded data to a subscriber.

10. A system for combining and separating a plurality of non-orthogonal signals in a multi-channel communication system comprising:
a channel forming component comprising a plurality of binary data sources, a set of non-orthogonal signal generators, and an adder; and
a separating component comprising a band pass filter, an analog-to-digital converter and a solver-separator; and
wherein the separating component is configured to accept a group mixture from the channel forming component via a group channel with noise and provide a channel separation of the plurality of non-orthogonal signals.

11. The system of claim 10, wherein the channel forming component is configured to generate a common group channel signal as a sum of modulated individual non-orthogonal signals.

12. The system of claim 10, wherein the band pass filter is a band pass selective filter.

13. The system of claim 10, wherein the band pass filter is configured to limit an effective spectrum of a signal-to noise mixture.

14. The system of claim 10, wherein the analog-to-digital converter is configured to transform a group signal into a digital form with a required sample rate.

15. The system of claim 10, wherein the set of non-orthogonal signal generators and the analog-to-digital converter are controlled by a system clock.

16. The system of claim 10, wherein the solver-separator is in communication with the band pass filter and the analog-to-digital converter.

17. The system of claim 10, wherein the solver-separator is configured to solve a system of linear algebraic equations based on a linear separating matrix.

18. A method for combining and separating a plurality of non-orthogonal signals in a multi-channel communication system and a multiple access system, the method comprising:
providing a channel forming component comprising a plurality of binary data sources, a set of non-orthogonal signal generators, and an adder;
providing a separating component comprising a band pass filter, an analog-to-digital converter and a solver-separator;
dividing a plurality of sequences of binary data symbols into a plurality of symbol blocks to modulate individual signals;
combining the plurality of symbol blocks with the adder to generate a common group channel signal as a sum of the modulated individual non-orthogonal signals;
limiting an effective spectrum of a signal-to noise mixture with the band pass filter; and
using the solver-separator to provide a discrimination of the signals of individual channels protected against noise distortion.

19. The method of claim 18 further comprising synchronizing the set of non-orthogonal signal generators and the analog-to-digital converter with a system clock.

20. The method of claim 18, wherein the solver-separator is configured to solve a system of linear algebraic equations based on a linear separating matrix.
